(19) United States
(12) Patent Application Publication
(10) Pub. No.: US 2012/0219241 A1
(43) Pub. Date: Aug. 30, 2012

(54) STORAGE BAG EXPANSION INSERT

(76) Inventor: Rodney Horton, Braintree, MA (US)

(21) Appl. No.: 13/033,830

(22) Filed: Feb. 24, 2011

(51) Int. Cl. B65D 33/02; B31B 1/26

(52) U.S. Cl. 383/34; 493/397

(57) ABSTRACT

An expandable insert to be used in flexible storage bags, and particularly to expand the flexible storage bag in such a manner as to hold the mouth of the bag open as well as provide a stable base so the bag is free-standing and self supporting to provide for hands-free filling of the bag with food or other materials by a user.

### FIELD OF THE INVENTION

The present invention relates to an expansion insert to be used in flexible storage bags, and particularly to expand the flexible storage bag in such a manner as to hold the mouth of the bag open as well as provide a stable base so the bag is free-standing and self supporting to provide for hands-free filling of the bag with food or other materials by a user.

### BACKGROUND OF THE INVENTION

Storage bags of paper, plastic or other flexible materials are often used to store and carry prepared foods, processed foods, household items, retail items or other materials. For some items such as sauce covered leftovers, cereal or crunchy pet food it is time consuming and messy to scoop and maneuver the items into a flexible storage bag. This is because such flexible storage bags are so supple that they are not self supporting and cannot stand on their own nor remain open. The storage bag or supple plastic for example has no rigid support structure to separate the sides of the bag and hold the bag upright and open to allow for easy filling of the bag without using one's hands. It is also not economically nor practicably feasible to manufacture such storage bags with a support structure which would take away from the utility of the bag to compress and surround the stored items thereby reducing and removing air from the bag to protect a food item and reduce the space necessary to store the filled bag. Accordingly, what is needed is a low cost, easy to clean, removable structure that may be inserted in the storage bag to maintain the bag in a temporary upright, self-supporting and open position for filling of the bag. The insert structure may then be easily removed to allow for compression of the bag around the stored items.

### SUMMARY OF THE INVENTION

According to the teachings of the present invention, a storage bag expansion insert is provided fabricated from a flexible and bendable, but yet rigid material. The expansion insert is generally a planar sheet material provided with apertures to facilitate bending of the insert along desired axes as well as apertures to hold, grip and even store the insert on a hook or hanger. The disclosed apparatus is formed of a flexible sheet plastic that while bendable and foldable along its width and length, has an elasticity which urges the device generally to retain its planar form when folding pressure is released from the device. When the device is folded around an axis the insert has an elasticity that pushes each side of the sheet apart about that axis. An aperture, knob or ridge is provided to align and grip the two ends of the plastic sheet together as the sheet bends around an axis. This facilitates insertion for the sheet to be slid into an empty flexible storage bag. By releasing the ends of the sheet in the bag, the elasticity of the sheet naturally separates the two sides of the insert pushing out on the sides of the flexible bag and providing for the rigidity of the insert across its width to hold the bag in an open and upright position.

The storage bag may then be filled. Also one or more apertures, nubs or ridges may be situated on either side of the insert and would provide for easy gripping to grasp the insert and draw it up and out of the filled storage bag. The insert is made of a non-toxic, washable material which may then be washed in a sink or dishwasher to remove food material providing for the insert to be reused. Upon removal of the insert the elasticity would allow the sheet to expand and essentially lay flat for hanging and/or storage. The insert may be of a composite or homogenous plastic that would be sufficiently heat resistant to prevent deformation when washing and also maintain its elasticity.

Depending upon the elastic characteristics, the insert may have a perforated or predefined axis for repeatable bending along that axis thereby defining the length of each side to match the dimensions of the storage bag. For example, although other sizes are certainly possible, the insert dimension may be in a range of about from 4″ to 12″ in height and 6″ to 20″ in length and bend about an axis 3″ to 10″ defined approximately in the middle of the length of the insert. When appropriately bent the insert would have respective side lengths of approximately 3″ to 10″ to fit in and press out upon the similarly dimensioned, generally slightly larger dimensioned sides of a flexible storage bag. Upon removal from the storage bag, the elasticity of the insert will allow the insert to essentially expand back into its planar state and separate, but because of the previous bend or fold, the insert may not lay completely flat and planar.

In a preferred embodiment the insert may have no defined fold, and instead may only bend or fold along any portion of the insert determined by the user's arrangement and manipulation of the planar insert into the storage bag. Without a defined fold, the sheet of preferably 4″ to 8″ in height and 8″ to 16″ in length, the axis of the fold may be adjusted to accommodate the dimensions of the storage bag with the elasticity of the insert providing the expansion of the insert to hold bags of various dimensions in an upright and open position. The flexibility of the insert allows the gripping and holding of the two sides of the insert together along an arbitrary fold axis with minimal force and no additional force is required to flatten and press the two sides of the sheet together, since the insert must only be folded a sufficient amount to place the insert inside the storage bag and then release the insert. The fold of the insert will appear rounded and then upon removal from the bag and release, the insert will expand or un-flex and lay completely flat for storage. An important aspect of the present invention is that the insert may be smaller or larger in dimension to the storage bag but still provide the rigidity when inserted in the bag to maintain the bag in an open, self-supporting and upright position.

It is an object of the present invention to provide an insert that maintains a flexible storage bag in an upright and open position.

It is another object of the invention that minimal force is exerted to hold the insert in a folded position for insertion in a flexible storage bag.

It is another object of the invention that access points for gripping or pulling of the insert are provided to hold, insert and remove the insert from the flexible storage bag.

It is another object of the present that the insert be reusable and is made of a washable material.

It is a further object of the present invention that the insert be usable with storage bags of various dimensions and materials.

The invention is further directed to an expandable insert for a flexible storage container comprising a substantially planar sheet of flexible material having a front face and a back face defined by a pair of opposing end edges and a pair of opposing side edges; a plurality of at least one of perforations, apertures and indentations formed in the front and back faces of the planar sheet and positioned adjacent each opposing end edges of the planar sheet; and wherein the expandable insert has a first state defined by the planar sheet being in an unbiased and substantially planar arrangement, and a second state defined by a bend being placed in the planar sheet to form opposing and biased leg portions of the insert biased on either side of the bend in the planar sheet.

The present invention is also directed to a method of supporting a flexible storage container using an expandable insert comprising the steps of forming a substantially planar sheet of flexible material having a front face and a back face defined by a pair of opposing end edges and a pair of opposing side edges; providing a plurality of at least one of perforations, apertures and indentations formed in the front and back faces of the planar sheet and positioned adjacent each opposing end edges of the planar sheet; and defining a first state wherein the planar sheet is in an unbiased and substantially planar arrangement and defining a second state by placing a bend in the planar sheet to form opposing and biased leg portions of the insert biased on either side of the bend in the planar sheet.

These aspects of the invention are not meant to be exclusive and other features, aspects, and advantages of the present invention will be readily apparent to those of ordinary skill in the art when read in conjunction with the appended claims and accompanying drawings.

### DESCRIPTION OF THE DRAWINGS

These and other features and advantages of the present invention will be better understood by reading the following detailed description, taken together with the drawings wherein:

FIG. 1 is a diagrammatic view of a first embodiment of the insert;

FIG. 2 is a diagrammatic view of a first embodiment of the insert in a folded position with a flexible storage bag;

FIG. 3 is a diagrammatic view of a first embodiment of the insert aligned with and being inserted in the storage bag;

FIG. 4 is a diagrammatic view of a first embodiment of the insert within the storage bag and holding the bag in an upright open position being filled with items of material;

FIG. 5 is a diagrammatic view of a first embodiment of the insert extracted from the filled the storage bag;

FIG. 6 is a diagrammatic view of a first embodiment of the insert ready to be washed and stored;

FIGS. 7 and 7A is a diagrammatic view of a first embodiment of the insert showing the fill area;

FIGS. 8 and 8A is a diagrammatic view of a further embodiment of the insert showing two folds and the fill area;

FIG. 9 is a diagrammatic view of a preferred embodiment of the insert;

FIG. 10 is a diagrammatic view of a preferred embodiment of the insert in a folded position with a flexible storage bag;

FIG. 11 is a diagrammatic view of a preferred embodiment of the insert aligned with and being inserted in the storage bag;

FIG. 12 is a diagrammatic view of a preferred embodiment of the insert within the storage bag and holding the bag in an upright open position being filled with items of material;

FIG. 13 is a diagrammatic view of a preferred embodiment of the insert extracted from the filled the storage bag;

FIG. 14 is a diagrammatic view of a preferred embodiment of the insert ready to be washed and stored;

FIGS. 15 and 15A is a diagrammatic view of a first embodiment of the insert showing the fill area;

FIGS. 16 and 16A is a diagrammatic view of a preferred embodiment of the insert showing the fill area.

### DETAILED DESCRIPTION OF THE INVENTION

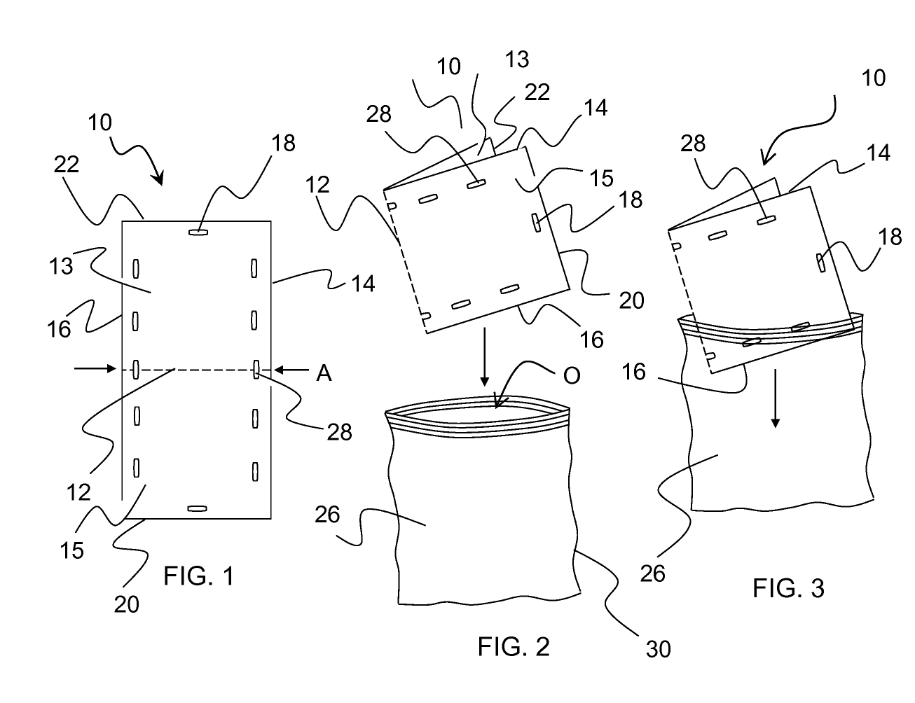

A first embodiment of the insert 10 for flexible storage bags is shown in FIG. 1. In this embodiment a defined or perforated fold 12 is formed in the sheet material approximately in the middle of the insert forming a center axis A extending between a first side edge 14 and second side edge 16 of the insert 10. End apertures 18 are formed at or adjacent the opposing end edges 20, 22 of the insert to provide a gripable portion of the insert and also side edge apertures 28 may be formed along the axis A to facilitate a user folding the insert along the axis A to match the first and second end edges 20, 22 and thus prepare the insert 10 for insertion in a storage bag 26 as shown in FIG. 2. It is to be appreciated that the end apertures 18 could also be nubs, perforations, raised or indented and contoured material that makes the insert easier to manually handle.

In use, the insert is initially in a naturally planar form and a user folds or bends the insert 10 about the axis A so that the insert is essentially folded in half, with each opposing half of the insert essentially defining a leg 13, 15 of the insert 10. The natural resiliency of the insert material gives the legs 13, 15 of the folded or bent insert a natural tendency to want to lay flat again, so the legs are provided with an outward bias when bent or folded. A user may grip the now folded insert 10 by the end apertures 18 with one hand, and the flexible bag 26 can be held open with the user's other hand and the insert 10 is slid or placed through the opening O of the storage bag 26 as shown in FIG. 3. The insert 10 is placed in the bag so the lowermost side edge, either 14 or 16, extends towards the bottom of the bag. When the user releases the ends 20, 22 of the insert, the natural resilience of the legs 13, 15 want to return the insert to its generally planar condition, which causes the legs 13, 15 to push outward on the sides of the bag 26 to widen the bag and opening O. This outward expansion of the legs also forms a stable base for the supported bag 26 due to the lowermost side edge 14, 16 of the insert forming a substantially planar surface are along the bottom portion of the storage bag 26.

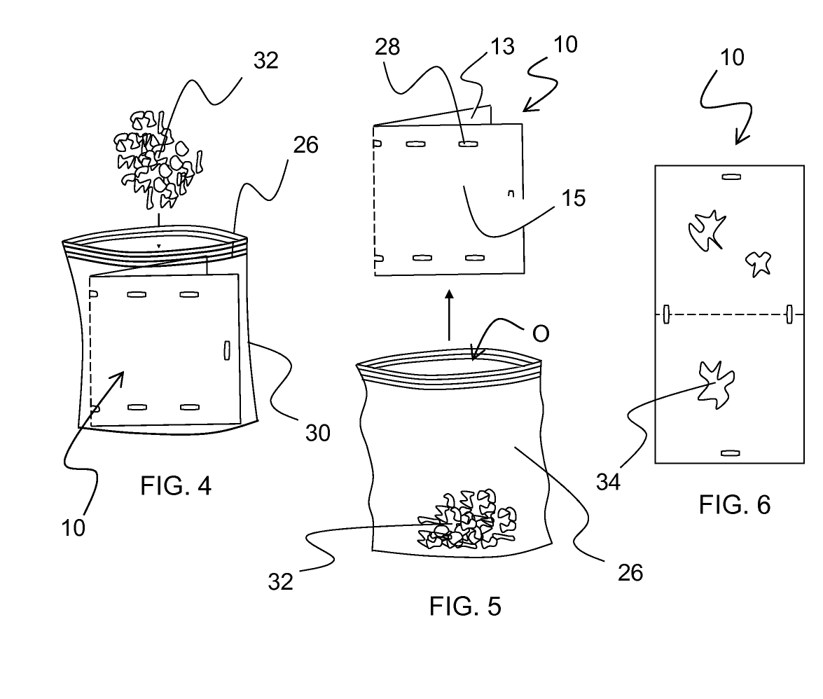

The width of the insert 10 between the side edges 14, 16 may be about the same height as the bag, but could be shorter than the bag or even taller than the sidewalls of the bag and still provide the rigidity to force the bag 26 into an open position for filling of items of material 32, as shown in FIG. 4. Generally the legs 13, 15 of the insert 10 will be shorter than the width of the storage bag so that the insert can be inserted easily into the bag without overlapping the free ends of the legs 20, 22. This allows the free ends of the legs 13, 15 to push out on the sidewalls of the bag opening the bag as widely as possible.

With the storage bag 26 now supported and free standing with opening O biased open by the inherent natural bias of the legs 13, 15 material or items 32 to be stored in the bag 26 may be poured, dropped, slid or otherwise deposited into the bag 26 and over and past the insert 10 to fill the bag 26. The insert provides a smooth surface on both legs 13, to direct the flow of items 32 into the bag 26 rapidly and without mess.

The storage bag 26 may be of any flexible material such as paper, plastic or other composites, with the insert 10 working equally as well for bags both that have a partial base such as a paper bag, or plastic storage bags which have no integral base where a single linear seam defines the bottom of the storage bag 26 as defined by the two opposing sidewalls of the bag such as a plastic sandwich bag or freezer bag. The insert 10 provides a rigid wall within the bag 26 to facilitate support of the bag 26 and capture of the items or material 32 deposited into the bag.

After filling the insert 10 may be manually retracted using the side edge apertures 28 or perforations along the middle of the insert, generally along the axis A. A user may grip the side edge apertures 28 adjacent the uppermost side edge 14, 16 so the insert may be pulled out of the bag 26. With side edge apertures located adjacent both side edges, 14, 16 the insert 10 may be inserted into the bag 26 in either direction and an access point to grip the bag 26 is always provided. The insert 10 is removed from the bag 26 as shown in FIG. 5 and then is ready for cleaning of stains 34 and storage as shown in FIG. 6.

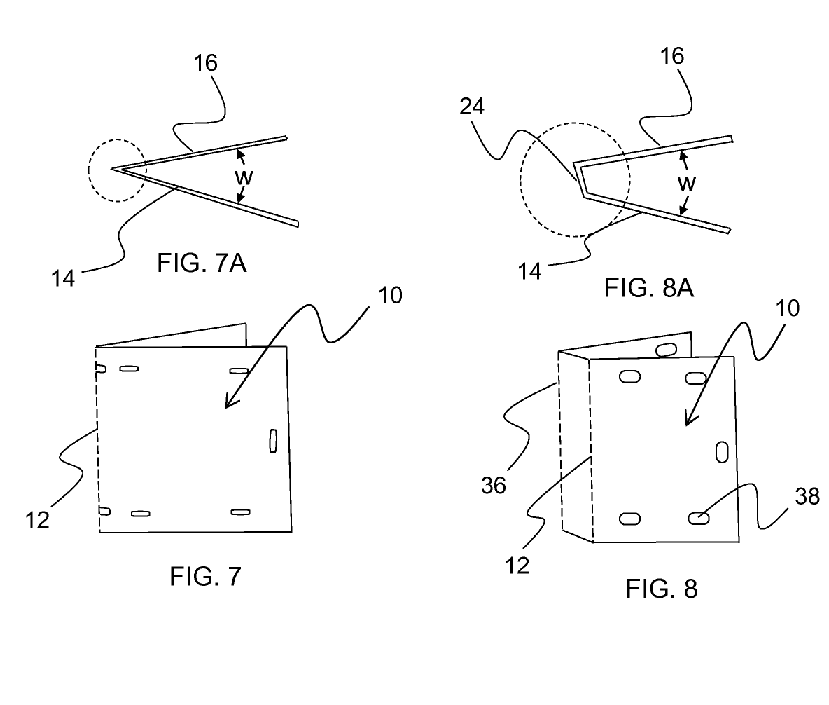

In this first embodiment, the perforated fold 12, also often referred to as a living hinge, allows very little force to be used to fold the insert 10, however with a single fold in one position on the insert 10, the dimensions of the insert remain substantially constant and the area w between each of the side inserts 14, 16 is somewhat limited for filling of material as shown in FIGS. 7 and 7A. In a further embodiment one or more additional folds 36 may be added to the insert 10 to add an end 24 and create a larger filling area w as shown in FIGS. 8 and 8A. The ridges 38 of the further embodiment may also be in various shapes or be simply cutouts in the insert 10 that allow a finger or thumb to be placed in the hole to fold and maneuver the insert 10. Either of these embodiments would accommodate many various dimensions and material storage bags 26 and additional folds 36 with a securing mechanism such as a rubber band could secure the insert 10 in a folded position for storage, reducing storage space.

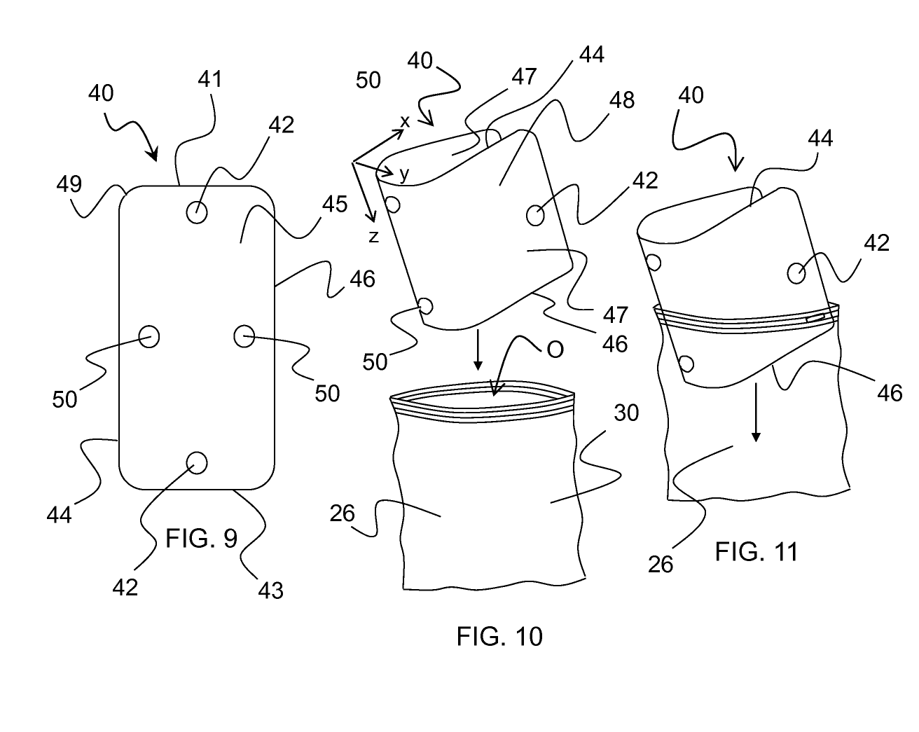

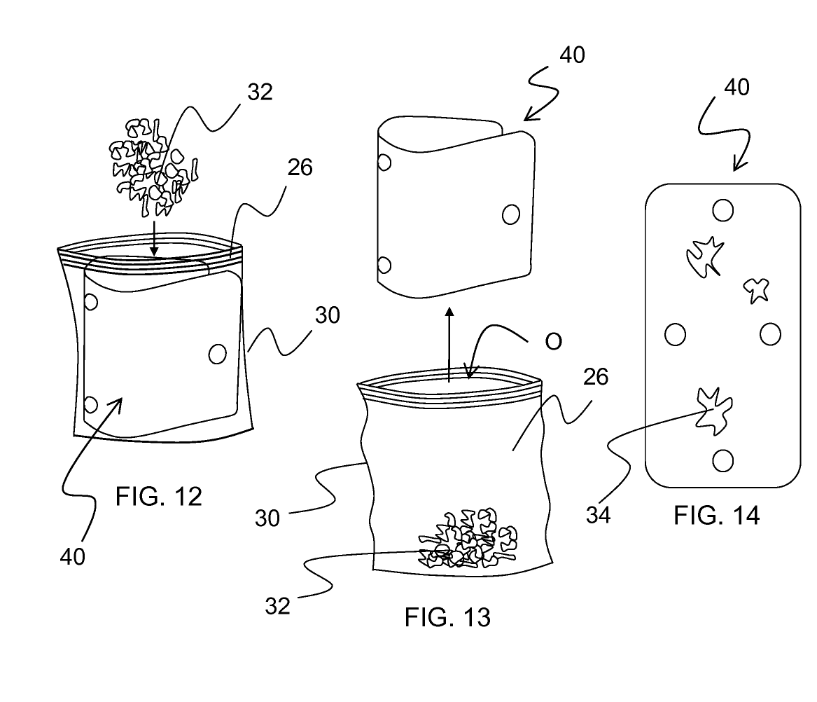

In a further embodiment, as shown in FIG. 9 the insert 40 is made of flexible yet rigid sheet of planar material, for example plastic although other materials could be used as well. The insert 40 has no defined folds or seams to specifically define an axis to bend or fold the insert 40 however the use of the insert is substantially the same as that above, to bend the insert 40 in such a manner as to fit the insert 40 into the flexible plastic bag.

The insert 40 is fabricated to have a generally planar structural arrangement or form as shown. The insert 40 is fabricated from a material having the proper elasticity to be flexed and bent in two dimensions, while remaining substantially stiff in a third dimension, but yet also return to its generally planar form as shown in FIG. 9 when removed from the flexible bag. An aperture 42 is provided adjacent each end edge 41, 43 of the insert to facilitate manual bending and handling of the insert 40. For example, a user may use one hand to hold the end edges 41, 43 of the insert together by each of essentially matching apertures 42, so that the insert is bent as shown in FIGS. 10-11 and can be inserted in a flexible storage bag 26 as shown in FIGS. 10 and 11. Smooth surfaces 45 on the opposing faces 47, 48 of the insert 40 allow the insert 40 to be easily slid into the flexible bag 26.

Also formed in this embodiment are a pair of opposing side apertures 50 formed along the side edges 44, 46 of the insert 40, for example as shown here approximately midway along the length of the insert 40. In use, the insert 40 is initially in a naturally planar form and a user bends the insert 40 so that the insert is essentially folded in half, with each opposing half of the insert essentially defining a leg 47, 48 of the insert 40. It is to be appreciated that the fold does not have to occur in the middle portion but could occur anywhere along the length of the insert 40. Also, the opposing side apertures 50 which are essentially missing material at about the midpoint of the insert 40 can facilitate the bending of the insert 40.

The natural resiliency of the insert material gives the legs 47, 48 of the folded or bent insert 40 a natural tendency to want to lay flat again, so the legs 47, 48 are provided with an outward bias when bent or folded. A user may grip the now folded insert 10 by the end apertures 42 with one hand, and the flexible bag 26 can be held open with the user's other hand and the insert 40 is slid or placed through the opening O of the storage bag 26 as shown in FIG. 11. The insert 40 is placed in the bag so the lowermost side edge, either 44 or 46, extends towards the bottom of the bag. When the user releases the ends 41, 43 of the insert, the natural resilience of the legs 47, 48 wants to return the insert 40 to its generally planar condition, which causes the legs 47, 48 to push outward on the sides of the bag 26 to widen the bag and opening O. This outward expansion of the legs also forms a stable base for the supported bag 26 due to the lowermost side edge 44 or 46 of the of the leg portions of the insert 40 forming a substantially planar surface along the bottom portion of the storage bag 26.

The insert 40 is provided with rounded corners 49 that also assist in sliding the insert in to bag and assisting in preventing punctures of the flexible storage bag material. The insert 40 straightens the edges 30 of the storage bag supporting the bag to stand upright and opened. The storage bag 26 may then be filled with the legs 47, 48 providing a rigid walled area for the items 32 of material to be poured, scoop, dropped or placed into the bag 26. The gripping holes 50 on each side of the insert 40 allow for the insert to be slid into the bag in either direction with a gripping hole still accessible for removal of the insert 40 from the storage bag 26. As shown in FIGS. 13 and 14 after removal the insert is ready to be cleaned of stains 34 and stored by laying the insert completely flat.

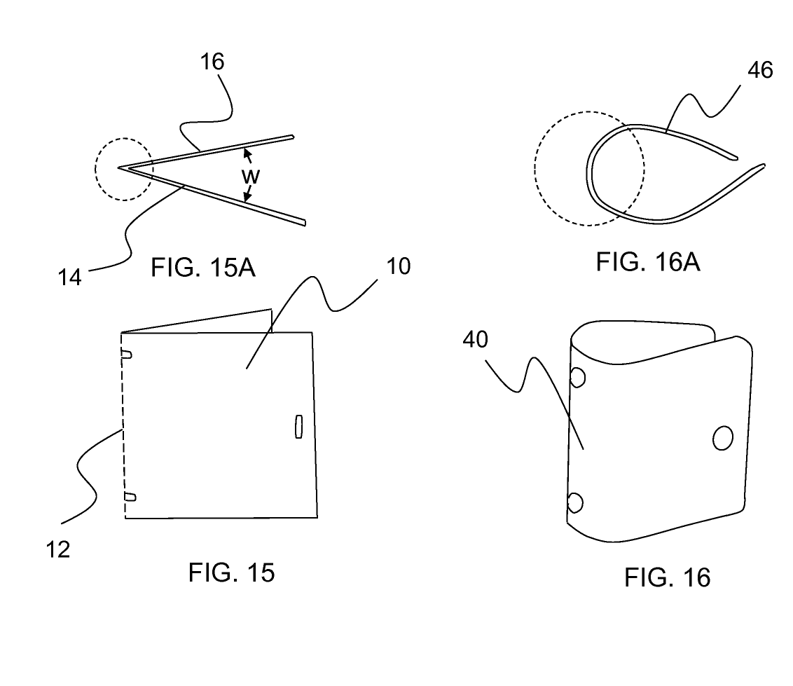

The removal of folds from the preferred embodiment reduces costs in manufacturing and provides for an even greater filling area w as shown in FIGS. 16 and 16A as compared to the filling area w of the first embodiment as shown in FIGS. 15 and 15A. The inserts 40 of the preferred embodiment may be made in different dimensions for example a height in the range of about 4″ to 16″ and a length of 6″ to 20″ to accommodate small and large storage bags 26 of various dimensions and materials. The preferred insert 40 may also be of a suitable material to be heat resistant to deformation, so that the insert 40 may be hand washed or placed in a dishwasher for cleaning.

The invention has been described in detail with particular reference to certain preferred embodiments thereof, but it will be understood that variations and modifications can be effected within the spirit and scope of the invention.

I/We claim:

1. An expandable insert for a flexible storage container comprising:
a substantially planar sheet of flexible material having a front face and a back face defined by a pair of opposing end edges and a pair of opposing side edges;
a plurality of at least one of perforations, apertures and indentations formed in the front and back faces of the planar sheet and positioned adjacent each opposing end edges of the planar sheet; and
wherein the expandable insert has a first state defined by the planar sheet being in an unbiased and substantially planar arrangement, and a second state defined by a bend being placed in the planar sheet to form opposing and biased leg portions of the insert biased on either side of the bend in the planar sheet.

2. The expandable insert as set forth in claim 1 wherein the bend is formed at about a midpoint along a length of the planar sheet and each perforation, aperture and indentation formed in the front and back faces of the planar sheet and positioned adjacent each opposing end edges of the planar sheet is substantially overlapped to facilitate insertion of the expandable insert into the flexible storage container.

3. The expandable insert as set forth in claim 1 further comprising at least one of perforations, apertures and indentations formed in the front and back faces of the planar sheet and positioned adjacent each opposing side edges of the planar sheet.

4. The expandable insert as set forth in claim 3 wherein the perforations, apertures and indentations adjacent each opposing side edges of the planar sheet are formed at about the midpoint of the planar sheet to facilitate the bending of the planar sheet in second state of the expandable insert.

5. The expandable insert as set forth in claim 1 wherein in the second state the expandable insert is placed within the flexible container and the opposing and biased leg portions of the insert press against wall portions of the flexible container to facilitate maintaining the flexible container in a desired orientation.

6. The expandable insert as set forth in claim 5 wherein the opposing biased leg portions of the insert pressing on the wall portions of the flexible container define a substantially planar base portion to support the flexible container in a self-supporting upright arrangement.

7. A method of supporting a flexible storage container using an expandable insert comprising the steps of:
forming a substantially planar sheet of flexible material having a front face and a back face defined by a pair of opposing end edges and a pair of opposing side edges;
providing a plurality of at least one of perforations, apertures and indentations formed in the front and back faces of the planar sheet and positioned adjacent each opposing end edges of the planar sheet; and
defining a first state wherein the planar sheet is in an unbiased and substantially planar arrangement and defining a second state by placing a bend in the planar sheet to form opposing and biased leg portions of the insert biased on either side of the bend in the planar sheet.

8. The method of supporting a flexible storage container using an expandable insert as set forth in claim 7 comprising the further steps of forming the bend at about a midpoint along a length of the planar sheet and each perforation, aperture and indentation formed in the front and back faces of the planar sheet and positioned adjacent each opposing end edges of the planar sheet is substantially overlapped to facilitate insertion of the expandable insert into the flexible storage container.

9. The method of supporting a flexible storage container using an expandable insert as set forth in claim 1 further comprising the steps of forming at least one of perforations, apertures and indentations in the front and back faces of the planar sheet and adjacent each opposing side edges of the planar sheet.

10. The method of supporting a flexible storage container using an expandable insert as set forth in claim 9 further comprising the step of forming the perforations, apertures and indentations adjacent each opposing side edges of the planar sheet at about the midpoint of the planar sheet to facilitate the bending of the planar sheet in the second state of the expandable insert.
